(19) United States
(12) Patent Application Publication
(10) Pub. No.: US 2026/0217249 A1
(43) Pub. Date: Jul. 30, 2026

(54) SMART OFFERING FOR TRAILER HITCHING ASSISTANCE

(71) Applicant: Ford Global Technologies, LLC, Dearborn, MI (US)

(72) Inventors: Mohamed El-sawah, Canton, MI (US); Robert Bell, New Hudson, MI (US); Roger Arnold Trombley, Ann Arbor, MI (US); Keenan Kurtz, Royal Oak, MI (US); Vainatey Kulkarni, Windsor (CA); Ali Delbari, Windsor (CA)

(73) Assignee: Ford Global Technologies, LLC, Dearborn, MI (US)

(21) Appl. No.: 19/037,532

(22) Filed: Jan. 27, 2025

(51) Int. Cl. B60W 30/18; B60W 50/14; G06V 20/58

(52) U.S. Cl. CPC B60W 30/18036; B60W 50/14; G06V 20/58; B60W 2420/403; B60W 2510/1005; B60W 2510/20; B60W 2520/06; B60W 2540/215; B60W 2554/80; B60W 2556/50; B60W 2710/207

(57) ABSTRACT

A hitching assistance system for a vehicle includes an imager mounted with and directed away from a rear of the vehicle and outputting image data, a transmission state indicator mounted within the vehicle, a vehicle-human machine interface positioned within the vehicle, and a controller. The controller monitors the transmission state indicator and, responsive to the transmission indicator corresponding with the vehicle being in reverse acquires image data from the imager, identifies a trailer within the image data, and responsive to identifying the trailer within the image data, presenting, via the vehicle-human machine interface, an option for user selection for initiation of an automated hitching maneuver. The controller further, responsive to acceptance of the option, outputs a steering signal to the vehicle to cause the vehicle to steer to position the vehicle relative to the trailer such that the trailer can be coupled with the vehicle.

### FIELD OF THE DISCLOSURE

The present disclosure generally relates to a system for automating the alignment of a vehicle with a trailer, and more particularly to a system that includes a quick start function.

### BACKGROUND OF THE DISCLOSURE

The process of hitching a trailer to a vehicle can be challenging and time-consuming, often requiring precise alignment and multiple attempts to achieve a proper connection. Traditional methods rely heavily on the driver's skill and experience, which can lead to frustration and multiple attempts to hitch the trailer. As vehicles and trailers become more advanced, there is a growing need for automated systems that can assist drivers in hitching trailers more efficiently and accurately.

### SUMMARY OF THE DISCLOSURE

According to one aspect of the present disclosure, a hitching assistance system for a vehicle includes an imager mounted with and directed away from a rear of the vehicle and outputting image data, a transmission state indicator mounted within the vehicle, a vehicle-human machine interface positioned within the vehicle, and a controller. The controller monitors the transmission state indicator and, responsive to the transmission indicator corresponding with the vehicle being in reverse acquires image data from the imager, identifies a trailer within the image data, and responsive to identifying the trailer within the image data, presents, via the vehicle-human machine interface, an option for user selection for initiation of an automated hitching maneuver. The controller further, responsive to acceptance of the option for user selection for the automated hitching maneuver, outputs a steering signal to the vehicle to cause the vehicle to steer to position the vehicle relative to the trailer such that the trailer can be coupled with the vehicle.

Embodiments of the first aspect of the invention can include any one or a combination of the following features:
The controller further, responsive to the transmission indicator corresponding with the vehicle being in reverse, can determine a trailer target area to a rear of the vehicle and present the option for user selection for initiation of the automated hitching maneuver, further responsive to at least a portion of the trailer being within the trailer target area.
The controller can further identify a coupler of the trailer within the image data, and the portion of the trailer within the trailer target area can be the coupler of the trailer.
The trailer target area can be positioned within left and right lateral vehicle steering limits that are defined in a lateral direction between left and right boundaries respectively spaced inwardly of the left and right lateral vehicle steering limits by one of a system perception factor or a vehicle geometry factor and defined in a longitudinal direction between a minimum movement limit and a maximum perception limit.
The option for user selection for initiation of the automated hitching maneuver can be presented within a quick-start mode implemented by the controller responsive to identifying the trailer within the image data.
The controller can deactivate the quick-start mode after a predetermined interval with no acceptance of the option for user selection for initiation of the automated hitching maneuver.
While outputting the steering signal to the vehicle to cause the vehicle to steer to position the vehicle relative to the trailer such that the trailer can be coupled with the vehicle, the controller can further attempt to identify a vehicle hitch ball within the image data and responsive to not detecting a hitch ball when the vehicle moves to within a predetermined distance of the trailer, can cause the vehicle to stop and can also present an indication, via the vehicle-human machine interface that a hitch ball should be assembled with the vehicle.
The option for user selection for initiation of the automated hitching maneuver can be presented as a top-level selection item on the vehicle-human machine interface.
The top-level selection item on the vehicle-human machine interface can be presented as an overlay on at least a portion of the image data presented on a display of the vehicle-human machine interface.
The controller can further present an indication of the identified trailer as a second overlay on the portion of the image data.
The hitching assistance system can further include a GPS module and memory including a stored location of a trailer, and, responsive to the transmission indicator corresponding with the vehicle being in reverse, the controller can further monitor a position of the vehicle relative to the stored location of the trailer using the GPS module and presenting the option for user selection for initiation of the automated hitching maneuver in further response to the vehicle being within a predetermined positioning relative to the stored location of the trailer.

According to another aspect of the present disclosure, a hitching assistance system for a vehicle includes an imager mounted with and directed away from a rear of the vehicle and outputting image data, a GPS module positioned within the vehicle, a transmission state indicator mounted within the vehicle, and a controller. The controller monitors the transmission state indicator and, responsive to the transmission indicator corresponding with the vehicle being in reverse, uses at least one of the imager or the GPS module to determine if the vehicle is within a predetermined position relative to a trailer. Responsive to determining that the vehicle is within the predetermined position relative to the trailer, the controller presents, via the vehicle-human machine interface, an option for user selection for initiation of an automated hitching maneuver. Responsive to acceptance of the option for user selection for the automated hitching maneuver, the controller outputs a steering signal to the vehicle to cause the vehicle to steer to position the vehicle relative to the trailer such that the trailer can be coupled with the vehicle.

According to another aspect of the present disclosure, a vehicle includes a steering system, a transmission system, an imager mounted with and directed away from a rear of the vehicle and outputting image data, a GPS module, a vehicle-human machine interface positioned within the vehicle, and a controller. The controller monitors a state of the transmission, and responsive to the state of the transmission indicator corresponding with the vehicle being in reverse, uses at least one of the imager or the GPS module to determining if the vehicle is within a predetermined position relative to a trailer. Responsive to determining that the vehicle is within the predetermined position relative to the trailer, the controller presents, via the vehicle-human machine interface, an option for user selection for initiation of an automated hitching maneuver. Responsive to acceptance of the option for user selection for the automated hitching maneuver, the controller outputs a steering signal to the vehicle to cause the vehicle to steer to position the vehicle relative to the trailer such that the trailer can be coupled with the vehicle.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of a vehicle in an unhitched position relative to a trailer;

FIG. 2 is a diagram of a system according to an aspect of the disclosure for assisting in aligning the vehicle with a trailer in a position for hitching the trailer to the vehicle;

FIG. 3 is an overhead schematic view of a vehicle during a step of the alignment sequence with the trailer;

FIG. 4 is a schematic depiction of a valid zone for trailer identification based on alignment with a vehicle including a system according to FIG. 2;

FIG. 5 is an example illustration of image data including a trailer presented on a display within a vehicle according to operation of the disclosed system;

FIG. 6 is an example illustration of image data including a trailer and overlayed with instructions presented on a display within a vehicle according to a further aspect of the operation of the disclosed system;

FIG. 7 is an example illustration of image data including a trailer and overlayed with a selection item presented on a display within a vehicle according to a further aspect of the operation of the disclosed system;

FIG. 8 is an example illustration of image data including a trailer and overlayed with additional instructions presented on a display within a vehicle according to a further aspect of the operation of the disclosed system;

FIG. 9A is a partial flowchart depicting operation of the disclosed system according to a further aspect of the disclosure; and

FIG. 9B is a remaining portion of the flowchart of FIG. 9A.

### DETAILED DESCRIPTION OF THE PREFERRED EMBODIMENTS

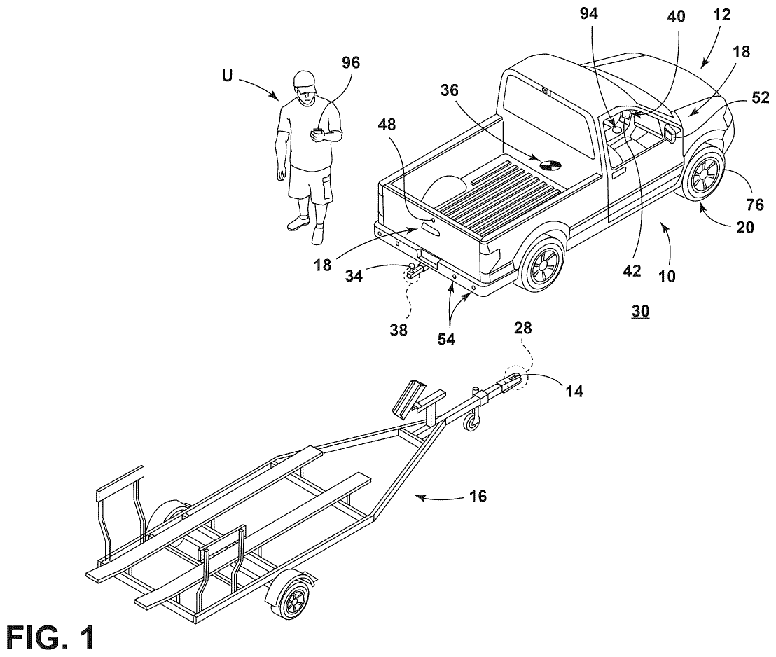

For purposes of description herein, the terms “upper,” “lower,” “right,” “left,” “rear,” “front,” “vertical,” “horizontal,” “interior,” “exterior,” and derivatives thereof shall relate to the device as oriented in FIG. 1. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

Ordinal modifiers (i.e., “first”, “second”, etc.) may be used to distinguish between various structures of the disclosed device in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

Referring to FIG. 1, reference numeral 10 generally designates a hitching assistance system for a vehicle includes an imager mounted with and directed away from a rear of the vehicle and outputting image data, a GPS module positioned within the vehicle, a transmission state indicator mounted within the vehicle, and a controller. The controller monitors the transmission state indicator and, responsive to the transmission indicator corresponding with the vehicle being in reverse, uses at least one of the imager or the GPS module to determine if the vehicle is within a predetermined position relative to a trailer. Responsive to determining that the vehicle is within the predetermined position relative to the trailer, the controller presents, via the vehicle-human machine interface, an option for user selection for initiation of an automated hitching maneuver. Responsive to acceptance of the option for user selection for the automated hitching maneuver, the controller outputs a steering signal to the vehicle to cause the vehicle to steer to position the vehicle relative to the trailer such that the trailer can be coupled with the vehicle.

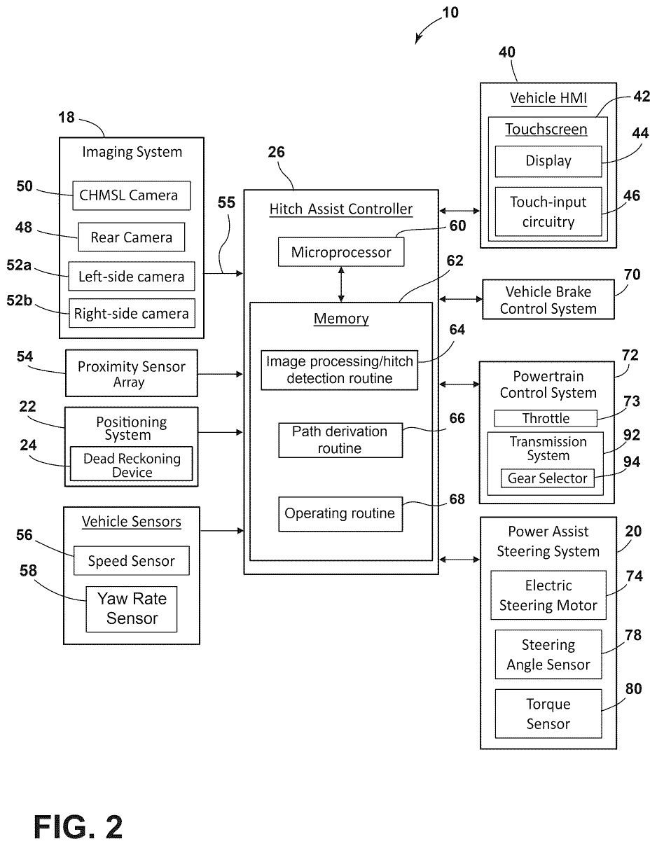

With respect to the general operation of the hitch assist system 10, as illustrated in the system diagram of FIG. 2, system 10 includes various sensors and devices that obtain or otherwise provide vehicle status-related information. This information includes positioning information from a positioning system 22, which may include a dead reckoning device 24 or, in addition or as an alternative, a global positioning system (GPS), to determine a coordinate location of the vehicle 12 based on the one or more locations of the devices within the positioning system 22. In particular, the dead reckoning device 24 can establish and track the coordinate location of the vehicle 12 within a localized coordinate system 82 based at least on vehicle speed and steering angle δ. Other vehicle information received by hitch assist system 10 may include a speed of the vehicle 12 from a speed sensor 56 and a yaw rate of the vehicle 12 from a yaw rate sensor 58. It is contemplated that in additional embodiments, a proximity sensor 54 or an array thereof, and other vehicle sensors and devices may provide sensor signals or other information, such as sequential images of a trailer 16, including the detected coupler 14, that the controller 26 of the hitch assist system 10 may process with various routines to determine the height H and position (e.g., based on the distance Dₕ and angle αₕ) of coupler 14.

As further shown in FIG. 2, one embodiment of the hitch assist system 10 is in communication with the steering system 20 of vehicle 12, which may be a power assist steering system 20 including an electric steering motor 74 to operate the steered wheels 76 (FIG. 1) of the vehicle 12 for moving the vehicle 12 in such a manner that the vehicle yaw changes with the vehicle velocity and the steering angle δ. In the illustrated embodiment, the power assist steering system 20 is an electric power-assisted steering (“EPAS”) system including electric steering motor 74 for turning the steered wheels 76 to a steering angle δ based on a steering command, whereby the steering angle δ may be sensed by a steering angle sensor 78 of the power assist steering system 20. The steering command may be provided by the hitch assist system 10 for autonomously steering during a trailer hitch alignment maneuver and may alternatively be provided manually via a rotational position (e.g., steering wheel angle) of a steering wheel of vehicle 12. However, in the illustrated embodiment, the steering wheel of the vehicle 12 is mechanically coupled with the steered wheels 76 of the vehicle 12, such that the steering wheel moves in concert with steered wheels 76, preventing manual intervention with the steering wheel during autonomous steering. More specifically, a torque sensor 80 is provided on the power assist steering system 20 that senses torque on the steering wheel that is not expected from autonomous control of the steering wheel and therefore indicative of manual intervention, whereby the hitch assist system 10 may alert the driver to discontinue manual intervention with the steering wheel and/or discontinue autonomous steering. In alternative embodiments, some vehicles have a power assist steering system 20 that allows a steering wheel to be partially decoupled from movement of the steered wheels 76 of such a vehicle 12.

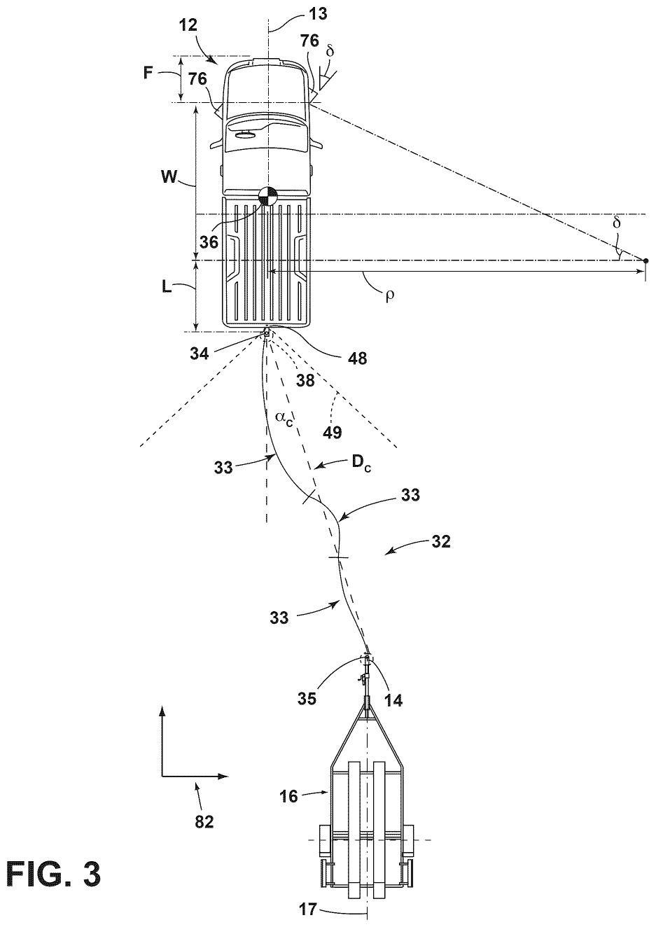

With continued reference to FIG. 2, the power assist steering system 20 provides the controller 26 of the hitch assist system 10 with information relating to a rotational position of steered wheels 76 of the vehicle 12, including a steering angle δ. The controller 26 in the illustrated embodiment processes the current steering angle, in addition to other vehicle 12 conditions to guide the vehicle 12 along the desired path 32 (FIG. 3). It is conceivable that the hitch assist system 10, in additional embodiments, may be an integrated component of the power assist steering system 20. For example, the power assist steering system 20 may include a hitch assist algorithm for generating vehicle steering information and commands as a function of all or a portion of information received from the imaging system 18, the power assist steering system 20, a vehicle brake control system 70, a powertrain control system 72, and other vehicle sensors and devices, as well as a human-machine interface 40, as discussed further below.

As also illustrated in FIG. 2, the vehicle brake control system 70 may also communicate with the controller 26 to provide the hitch assist system 10 with braking information, such as vehicle wheel speed, and to receive braking commands from the controller 26. For instance, vehicle speed information can be determined from individual wheel speeds as monitored by the brake control system 70. Vehicle speed may also be determined from the powertrain control system 72, the speed sensor 56, and the positioning system 22, among other conceivable means. In some embodiments, individual wheel speeds can also be used to determine a vehicle yaw rate \dot{γ}, which can be provided to the hitch assist system 10 in the alternative or in addition to the vehicle yaw rate sensor 58. The hitch assist system 10 can, further, provide vehicle braking information to the brake control system 70 for allowing the hitch assist system 10 to control braking of the vehicle 12 during backing of the trailer 16. For example, the hitch assist system 10, in some embodiments, may regulate speed of the vehicle 12 during alignment of the vehicle 12 with the coupler 14 of trailer 16, which can reduce the potential for a collision with trailer 16, and can bring vehicle 12 to a complete stop at a determined endpoint 35 of path 32. It is disclosed herein that the hitch assist system 10 can additionally or alternatively issue an alert signal corresponding to a notification of an actual, impending, and/or anticipated collision with a portion of trailer 16. The powertrain control system 72, as shown in the embodiment illustrated in FIG. 2, may also interact with the hitch assist system 10 for regulating speed and acceleration of the vehicle 12 during partial or autonomous alignment with trailer 16. As mentioned above, regulation of the speed of the vehicle 12 may be advantageous to prevent collision with trailer 16.

Additionally, the hitch assist system 10 may communicate with human-machine interface (“HMI”) 40 for the vehicle 12. The HMI 40 may include a vehicle display 44, such as a center-stack mounted navigation or entertainment display (FIG. 1). HMI 40 further includes an input device, which can be implemented by configuring display 44 as a portion of a touchscreen 42 with circuitry 46 to receive an input corresponding with a location over display 44. Other forms of input, including one or more joysticks, digital input pads, or the like can be used in place or in addition to touchscreen 42. Further, the hitch assist system 10 may communicate via wireless communication with another embodiment of the HMI 40, such as with one or more handheld or portable devices 96 (FIG. 1), including one or more smartphones. The portable device 96 may also include the display 44 for displaying one or more images and other information to a user. For instance, the portable device 96 may display one or more images of the trailer 16 on the display 44 and may be further able to receive remote user inputs via touchscreen circuitry 46. In addition, the portable device 96 may provide feedback information, such as visual, audible, and tactile alerts.

Still referring to the embodiment shown in FIG. 2, the controller 26 is configured with a microprocessor 60 to process logic and routines stored in memory 62 that receive information from the above-described sensors and vehicle systems, including the imaging system 18, the power assist steering system 20, the vehicle brake control system 70, the powertrain control system 72, and other vehicle sensors and devices. The controller 26 may generate vehicle steering information and commands as a function of all or a portion of the information received. Thereafter, the vehicle steering information and commands may be provided to the power assist steering system 20 for affecting steering of the vehicle 12 to achieve a commanded path 32 (FIG. 3) of travel for alignment with the coupler 14 of trailer 16. The controller 26 may include the microprocessor 60 and/or other analog and/or digital circuitry for processing one or more routines. Also, the controller 26 may include the memory 62 for storing one or more routines, including an image processing 64 routine and/or hitch detection routine, a path derivation routine 66, and an operating routine 68. It should be appreciated that the controller 26 may be a stand-alone dedicated controller or may be a shared controller integrated with other control functions, such as integrated with a vehicle sensor system, the power assist steering system 20, and other conceivable onboard or off-board vehicle control systems. It should further be appreciated that the image processing routine 64 may be carried out by a dedicated processor, for example, within a stand-alone imaging system 18 for vehicle 12 that can output the results of its image processing 64 to other components and systems of vehicle 12, including microprocessor 60. Further, any system, computer, processor, or the like that completes image processing functionality, such as that described herein, may be referred to herein as an “image processor” regardless of other functionality it may also implement (including simultaneously with executing image processing routine 64).

System 10 can also incorporate an imaging system 18 that includes one or more exterior cameras, which in the illustrated examples include rear camera 48, center high-mount stop light (CMHSL) camera 50, and side-view cameras 52a and 52b, although other arrangements including additional or alternative cameras are possible. In one example, imaging system 18 can include rear camera 48 alone or can be configured such that system 10 utilizes only rear camera 48 in a vehicle with multiple exterior cameras. In another example, the various cameras 48, 50, 52a, 52b included in imaging system 18 can be positioned to generally overlap in their respective fields of view, which in the depicted arrangement include fields of view 49, 51, 53a, and 53b to correspond with rear camera 48, center high-mount stop light (CMHSL) camera 50, and side-view cameras 52a and 52b, respectively. In this manner, image data 55 from two or more of the cameras can be combined in image processing routine 64, or in another dedicated image processor within imaging system 18, into a single image. In an extension of such an example, the image data 55 can be used to derive stereoscopic image data that can be used to reconstruct a three-dimensional scene of the area or areas within overlapped areas of the various fields of view of camera 48, as well as other available cameras 48, 50, 52a, 52b, including any objects (obstacles that may include additional trailers 16, as discussed further below, or coupler 14, for example) therein. In an embodiment, the use of two images including the same object can be used to determine a location of the object relative to the two image sources, given a known spatial relationship between the image sources. In this respect, the image processing routine 64 can use known programming and/or functionality to identify an object within image data 55 from the various cameras 48, 50, 52a, and 52b within imaging system 18. In either example, the image processing routine 64 can include information related to the positioning of any cameras 48, 50, 52a, and 52b present on vehicle 12 or utilized by system 10, including relative to the center 36 (FIG. 1) of vehicle 12, for example such that the positions of cameras 48, 50, 52a, and 52b relative to center 36 and/or to each other can be used for object positioning calculations and to result in object position data relative to the center 36 of vehicle 12, for example, or other features of vehicle 12, such as hitch ball 34 (FIG. 1), with known positions relative to center 36.

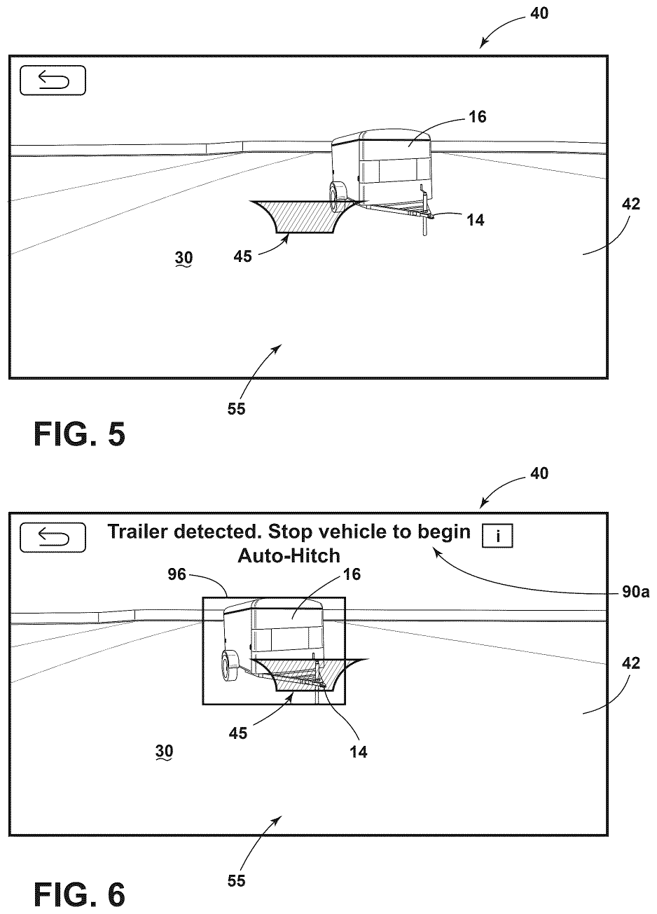

As shown in FIG. 5, the image processing routine 64 and operating routine 68 may be used in conjunction with each other to determine the path 32 along which hitch assist system 10 can guide vehicle 12 to align hitch ball 34 and coupler 14 of trailer 16. Upon initiation of hitch assist system 10, such as by user input on touchscreen 42, for example, image processing routine 64 can identify coupler 14 within the image data 55 and at least attempt to estimate the position 28 of coupler 14 relative to hitch ball 34 using the image data 55 in accordance with one of the examples discussed above to determine a distance D_{c} to coupler 14 and an angle α_{c} of offset between coupler 14 and the longitudinal axis 13 of vehicle 12. Image processing routine 64 can also be configured to identify the trailer 16 overall and can use the image data of trailer 16, alone or in combination with the image data of coupler 14, to determine the orientation or heading 33 of trailer 16. In this manner the path 32 can further be derived to align vehicle 12 with respect to trailer 16 with the longitudinal axis 13 of vehicle 12 within a predetermined angular range of the heading 33 of trailer 16. Notably, such alignment may not require that the longitudinal axis 13 of vehicle 12 is parallel or collinear with the heading 33 of trailer 16, but may simply be within a range that generally allows connection of hitch ball 34 with coupler 14 without collision between vehicle 12 and trailer 16 and may, further allow immediate controlled backing of trailer 16 using vehicle 12. In this manner, the angular range may be such that the alignment of vehicle 12 with trailer 16 at the end of the operating routine 68 is such that the angle between longitudinal axis 13 and heading 33 is less than the jackknife angle between the vehicle 12 and trailer 16 when coupled or a reasonable estimate thereof. In one example, the angular range may be such that longitudinal axis 13 is within about 30° from collinear with heading 33 in either direction. In various examples, such as when the length L of trailer 16 is known, the angular range may be greater, when permitted, or may be less, depending on the desired tolerance of system 10.

When collected, the position information can then be used in light of the position 28 of coupler 14 within the field of view of the image data 55 to determine or estimate the height H_{c} of coupler 14. Once the positioning D_{c}, α_{c} of coupler 14 has been determined and, optionally, confirmed by the user, controller 26 can take control of at least the vehicle steering system 20 to control the movement of vehicle 12 along the desired path 32 to align the vehicle hitch ball 34 with coupler 14, as discussed further below.

Continuing with reference to FIG. 3 with additional reference to FIG. 2, controller 26, having estimated the positioning D_{c}, α_{c} of coupler 14, as discussed above, can, in one example, execute path derivation routine 66 to determine vehicle path 32 to align the vehicle hitch ball 34 with coupler 14. In particular, controller 26 can have stored in memory 62 various characteristics of vehicle 12, including the wheelbase W, the distance from the rear axle to the hitch ball 34, which is referred to herein as the drawbar length L, as well as the maximum angle to which the steered wheels 76 can be turned δₘₐₓ. As shown, the wheelbase W and the current steering angle δ can be used to determine a corresponding turning radius p for vehicle 12 according to the equation:

$$ρ = \frac{1}{W tan δ} , \qquad ( 1 )$$

in which the wheelbase W is fixed and the steering angle δ can be controlled by controller 26 by communication with steering system 20, as discussed above. In this manner, when the maximum steering angle δₘₐₓ is known, the smallest possible value for the turning radius ρₘᵢₙ is determined as:

$$ρ \frac{1}{W tan {δ}_{{max}_{min}}} . \qquad ( 2 )$$

Path derivation routine 66 can be programmed to derive vehicle path 32 to align a known location of the vehicle hitch ball 34 with the estimated position 28 of coupler 14 that takes into account the determined minimum turning radius ρₘᵢₙ to allow path 32 to use the minimum amount of space and maneuvers. In this manner, path derivation routine 66 can use the position of vehicle 12, which can be based on the center 36 of vehicle 12, a location along the rear axle, the location of the dead reckoning device 24, or another known location on the coordinate system 82, to determine both a lateral distance to the coupler 14 and a forward or rearward distance to coupler 14 and derive a path 32 that achieves the needed lateral and forward-backward movement of vehicle 12 within the limitations of steering system 20. The derivation of path 32 further takes into account the positioning of hitch ball 34, based on length L, relative to the tracked location of vehicle 12 (which may correspond with the center 36 of mass of vehicle 12, the location of a GPS receiver, or another specified, known area) to determine the needed positioning of vehicle 12 to align hitch ball 34 with coupler 14. It is noted that hitch assist system 10 can compensate for horizontal movement Δx of coupler 14 in a driving direction away from its axle by determining the movement of coupler 14 in the vertical direction Δy that will be needed to receive hitch ball 34 within coupler 14. Such functionality is discussed further in co-pending, commonly-assigned U.S. Pat. No. 9,821,845, and 10,870,323, the entire disclosures of which are hereby incorporated by reference herein.

As discussed above, once the desired path 32, including endpoint 35, has been determined using either of the offset determination schemes discussed above, controller 26 is then allowed to at least control the steering system 20 of vehicle 12 with the powertrain control system 72 and the brake control system 70 (whether controlled by the driver or by controller 26, as discussed below) controlling the velocity (forward or rearward) of vehicle 12. In this manner, controller 26 can receive data regarding the position of vehicle 12 during movement thereof from positioning system 22 while controlling steering system 20, as needed to maintain vehicle 12 along path 32. In particular, the path 32, having been determined based on the vehicle 12 and the geometry of steering system 20, can adjust the steering angle δ, as dictated by path 32, depending on the position of vehicle 12 therealong. It is additionally noted that in an embodiment, the path 32 may comprise a progression of steering angle δ adjustment that is dependent on the tracked vehicle position.

As illustrated in FIG. 3, vehicle path 32 can be determined to achieve the needed lateral and rearward movement within the smallest area possible and/or with the lowest number of maneuvers. In the illustrated example of FIG. 3, path 32 can include two portions defined by steering of wheels 76 in different directions to collectively traverse the needed lateral movement of vehicle 12 to bring hitch ball 34 into the above-described offset alignment with coupler 14. It is noted that variations in the depicted path 32 may be used. It is further noted that the estimates for the positioning D_{c}, α_{c} of coupler 14 may become more accurate as vehicle 12 traverses path 32, including to position vehicle 12 in front of trailer 16 and as vehicle 12 approaches coupler 14. Accordingly, such estimates can be continuously derived and used to update path derivation routine 66, if necessary, in the determination of the adjusted endpoint 35 for path 32, as discussed above. It is further noted that, until such a determination can be made, the dead reckoning device 24 can be used to track the location of vehicle 12 in its movement along path 32 toward the initially-derived endpoint 35.

In one example, prior variations of the system 10 may be activated by navigating through menu options related to vehicle functions, which can be done via the HMI 40. In one such example, the above-described “hitch assist” functionality may be within a trailering function menu that can include a number of different options, including for storing various trailer characteristics in memory, as well as additional trailering system functions, including a trailer-backup assist function, such as that which is describe in U.S. Pat. No. 11,124,234, the entire contents of which are incorporated by reference herein. As is typically, the case, these menu options can be navigated to and/or selected using the touchscreen 42 of HMI 40 or by any type of directional controller typically found within a vehicle. In another example, a dedicated button or knob can be provided within the vehicle 12 for directly opening the sub-menu for trailer functions and/or the hitch assist function. While potentially requiring fewer steps than general menu navigation, activation of such functionality in this mode can still require multiple steps and would require some level of previous knowledge of the system capability and intent to use the system as such. In this manner, the present system 10 provides “quick start” functionality for activation of the hitch assist functionality, including the image processing 64, path generation derivation 66 and operating 68 routines. As discussed above, the controller 26 is configured to, responsive to determining that the vehicle 12 is within the “predetermined position” relative to the trailer 16, present, via the vehicle-human machine interface 40, the option for user selection for initiation of the automated hitching maneuver (i.e., the hitch assist functionality). Responsive to acceptance of the option for user selection for the automated hitching maneuver, the controller 26 executes the maneuver using the mentioned routines to outputs a steering signal to the vehicle 12 to cause the vehicle 12 to steer to position the vehicle 12 relative to the trailer 16 such that the trailer can 16 be coupled with the vehicle 12. Additionally, as discussed above, the controller 26 can also control, via corresponding signals, for example, the powertrain 72 and brake 70 systems to achieve the desired maneuvering and to stop the vehicle 12 at the desired position relative to the trailer 16.

As discussed further below, the functionality of the system 10 in automatically backing the vehicle 12 toward the trailer 16 may first require the vehicle 12 to be in the above-mentioned predetermined area relative to the trailer 16. Because such positioning may often require some initial reversing of the vehicle 12 toward the trailer 16 (and because a user unaware of such a capability of the vehicle 12 will back the vehicle 12 toward the trailer 16 under their own control), the quick start functionality may be initially triggered by the transmission system 92 being placed in reverse. Accordingly, the quick start functionality of system 10 can be configured to begin when the transmission system 92 is placed in reverse. In this manner, the controller 26 can monitor the transmission system 92 during operation, which may be done in general for reasons related to other vehicle systems or functions. In this manner, the transmission system 92 can include a transmission state indicator 94 that the controller 26 can leverage to determine when the vehicle 12 is in reverse.

As discussed above, upon activation of the quick start function, the system 10 can use at least one of the imager 48 and the GPS module 25 to determine if the vehicle 12 is in a predetermined position relative to a trailer 16. In one aspect, this can take place in multiple stages, with the system 10 initially determining if any trailer 16 are in the general area of the vehicle 12 (e.g., within about 50 feet or less). This can be done by monitoring the image data using the image processing routine 64 to determine if one or more trailers can be identified within the field of view of the camera 48. Additionally, or alternatively, the system 10 can be configured to store various trailer locations 16 in memory 62. In one example, this can happen by recording GPS coordinates for the vehicle 12 when a trailer 16 is disconnected therefrom, as discussed further in U.S. Pat. No. 10,780,752, the entire disclosure of which is incorporated herein. In this manner, when the vehicle 12 is in reverse, the controller 26 can check and monitor the GPS location of the vehicle 12 relative to the stored trailer locations to determine if a trailer 16 is nearby.

If it is determined if the vehicle 12 is in the general area of a trailer, the controller 26 can then work to determine if any trailers 16 to which the vehicle 12 is proximate are appropriate subjects for an automated hitching maneuver. In this manner, the imager (i.e., camera 48) can be used to determine if the vehicle 12 is within a predetermined position relative to any trailer 16. In one aspect, the predetermined position can be such that the trailer 16 is within a target area 45 relative to the vehicle 12. Depending on the particular implementation of system 10, the controller 26 may further identify a coupler 14 of the trailer 16, either initially or at some point during the automated backing operation. Accordingly, the condition of the vehicle being within a predetermined position relative to the trailer 16 can be determined by either the trailer 16 or the coupler 14 of the trailer 16 being within the target area 45 relative to the vehicle. Accordingly, under the above-described prerequisite conditions, the controller 26 further determines the trailer target area 45 to a rear of the vehicle (which can be done by simply recalling a predetermined area from memory and/or making conditional adjustments thereto).

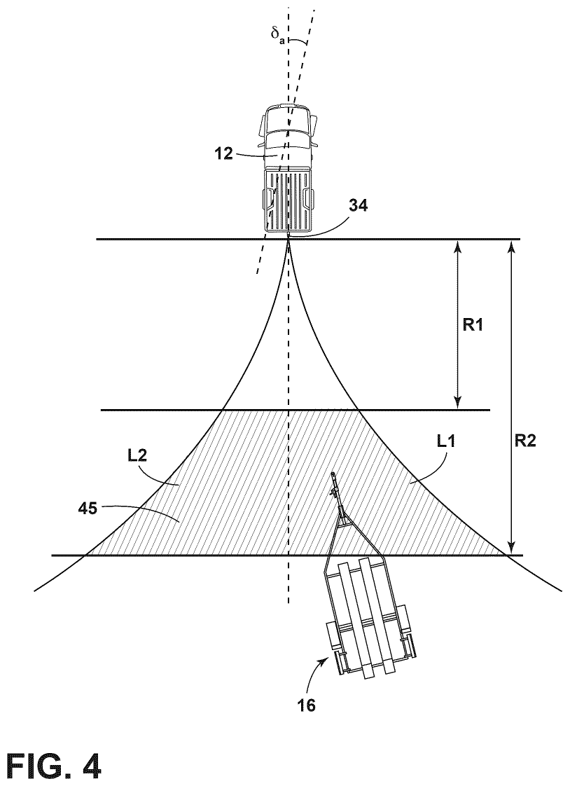

As shown in FIG. 4, the trailer target area 45 can be positioned within left and right lateral vehicle steering limits L1, L2 that are defined in a lateral direction between left and right boundaries respectively spaced inwardly of the left and right lateral vehicle steering limits L1, 12 by one of a system perception factor or a vehicle geometry factor and defined in a longitudinal direction between a minimum movement limit R1 and a maximum perception limit R2. Specifically, Various characteristics or limitations of system 10 may impact the ability of system 10 to identify trailers 16 (as well as the coupler 14, whenever such identification is carried out) in the data 55 received from imaging system 18 under certain conditions or in certain settings. Still further, various vehicle 12 or other system 10 characteristics may impact the ability of system 10 to navigate to reach a subject trailer 16 that is, nevertheless, present within the image data 55. Depending on the particular configuration of system 10, such characteristics can be partially driven by the imaging system 18 used by system 10. The imaging system 18 may be limited in its ability to identify any or all of trailers 16a-16f and/or the associated couplers 14a-14f within the entire field of the image data 55. In an example, it may be assumed, at least for simplicity of illustration, that system 10 only uses rear camera 48 for trailer 16 and coupler 14 detection, with rear camera 48 having a field of view 49 that is included in its entirety in the “total field” of the image data 55 (notably, if additional cameras 50,52a,52b are used, the total field of the image data 55 would include the entire assembled image from all such utilized cameras). The imaging system 18 limitations may limit overall system 10 functionality to only a limited distance between trailer coupler 14 and the vehicle 12, as different factors may limit the ability of controller 26 in identifying a trailer 16 or its coupler 14 when the trailer 16 and vehicle 12 are too close together or too far apart. For example, the resolution of the various cameras 48,50,52a,52b in imaging system 18 may impact the ability to identify any trailers 16a-16f or couplers 14a-14f beyond a maximum distance R1 from vehicle 12 with the particular value of R1 being influenced by ambient conditions, including available light and/or weather conditions (e.g., rain or snow).

Additionally, a minimum distance R2 for trailer 16 or coupler 14 detection may be realized because certain implementations of system 10 may rely on dynamic readings (such as of the ground surface behind vehicle 12 or other features visible around coupler 14) to calibrate system 10 and or to track vehicle 12 speed in reversing and to track the position of coupler 14 during system 10 operation. In particular, in the above example where only rear camera 48 is used by system 10, it may be necessary to detect motion within the field of view 49 to identify distance to the subject coupler 14 and to provide accurate tracking and boundary resolution (an aspect of image processing routine 64). Further, the operating routine 68 may include a longitudinal control algorithm that relies on precise control of the vehicle 12, and a minimum amount of travel distance corresponding with R2 in an example, is required to calibrate certain braking and powertrain variables to achieve such vehicle control. Still further, if a trailer 16 is too close to vehicle 12, various features of the trailer 16 may appear as trailers themselves to the image processing routine 64, meaning that to assist system 10, the trailer 16 should be beyond the minimum distance R2 such that a proportionality of features, including of trailer 16 itself as well as of trailer 16 relative to the total field of image data 55, is optimized for image processing routine 64 functionality.

Additionally, other limitations of system 10 functionality may add constraints to the acceptable zone of operation. In this respect, system 10 may not be capable of maneuvering vehicle 12 towards all locations in an initial view of the rear camera 48 (i.e., during trailer 16 or coupler 14 identification). In particular, system 10 is restricted in its ability to reach a potential target position due, but not limited, to a lateral span that is a function of a distance range and the steering angle δ limitations of vehicle 12. In one aspect, the maximum steering angle δₘₐₓ of the vehicle 12 determines the lateral range, as a function of distance D_{c} to coupler 14, as discussed further below. In general, an implementation of system 10 may restrict maneuvering of vehicle 12 to a single reversing motion that, while potentially including steering in both the left and right directions, does not incorporate forward driving of vehicle 12 between successive instances of reverse driving, for example. In this manner, the maximum lateral distance that can be traversed by vehicle 12 in an automated hitching operation is limited by the maximum steering angle δₘₐₓ. As the vehicle 12 travels laterally by turning the steered wheels 76 and reversing, the lateral limits of system operability 10 are determined as, essentially, a theoretical hitch ball 34 path extending rearward of the vehicle corresponding with steering of vehicle 12 at the maximum steering angle under reversing of vehicle to either side. In this manner, the lateral limits of system 10 may extend outwardly from vehicle 12, with increasing distance away from vehicle 12. In a further aspect, the steering angle δ may be limited to an angle δₐ that is lower than maximum steering angle δₘₐₓ based on predetermined constraints for allowable swing of the front end of vehicle 12. In this manner, the lateral limits of system 10 functionality may be further limited.

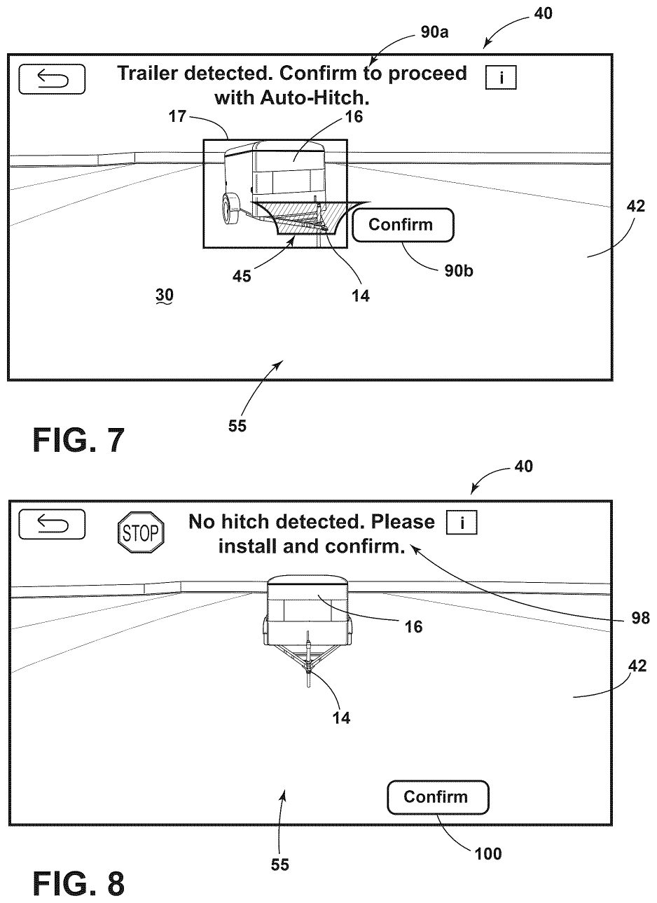

Because of these limitations, the present system 10 may be configured to only function when trailers 16 and its coupler 14 is positioned inside a “valid” region of space relative to the vehicle 12. The region is determined by the factors listed above, and, potentially, any additional factors that affect the system 10 capability. Accordingly, controller 26 can seek to determine if any proximate trailers 16 are within this target area 45 as a further prerequisite to initiation of the quick start functionality. In a further variation, when the detection of a trailer 16 is based on the use of stored location and GPS data, the position and pose of the vehicle 12 relative to the position that the vehicle was in when the location was stored can be compared to determine or help determine whether the trailer 16 is in the target area 45 relative to the vehicle 12. As shown in FIG. 5, when an identified trailer 16 is proximate to the vehicle, but not within the target area 45 (which is shown schematically, but may not actually be shown on the HMI 40), the system 10 will appear to function normally. When it has been determined that the vehicle 12 is appropriately positioned relative to the trailer 16, such that the trailer 16 is within the target area 45, as shown in FIG. 6, the option for user selection 90 for initiation of the automated hitching maneuver (i.e., via the quick start mode) can be presented via HMI 40. In one implementation, the system 10 may require that the vehicle be stopped before the automated hitching routine 68 can be activated. In this implementation, the option for user selection 90 can be presented in stages, with the initial option for user selection 90a, as shown in FIG. 6, being an indication that a trailer hitching target has been identified and instructing the user to stop the vehicle 12 to begin an automated hitching process. If the vehicle 12 is stopped (which can be detected by monitoring at least one of the positioning system 22, the brake control system 70, or the powertrain control system 72), the initial option message 90a can be removed and substituted with a top-level selection item 90b on the HMI 40. As shown in FIG. 7, the top-level selection item 90b can be presented as an overlay on at least a portion of the image data 55 presented on the touchscreen 42 display 44 of the HMI 40. In this manner, the option 90b can be configured as a “soft-button” such that the user, by pressing on the touchscreen 42 in the location of the option 90b, can indicate that auto hitching is desired. In one aspect, the controller 26 can further present an indication 94 of the identified trailer 16 as a second overlay on the portion of the image data 55 corresponding with the trailer 16, as also shown in FIG. 6. The controller 26 can deactivate the quick-start mode after a predetermined interval with no acceptance of the option (either 90a or 90b) for user selection for initiation of the automated hitching maneuver.

Returning to FIG. 3, once the quick-start option 90 is selected, the system 10 determines the path 32 to align hitch ball 34 with the coupler 14, the operating routine 68 may continue to guide vehicle 12 until hitch ball 34 is in the desired position relative to coupler 14 for coupler 14 to engage with hitch ball 34 when coupler 14 is lowered into horizontal alignment therewith. In the example discussed above, image processing routine 64 continuously monitors the positioning D_{c},α_{c} of coupler 14a, constantly or once available, during execution of operating routine 68, including as coupler 14 comes into clearer view of rear camera 48, with continued movement of vehicle 12 along path 32. The position of vehicle 12 can also be monitored by dead reckoning device 24 with the position 28 of coupler 14 being continuously updated and fed into path derivation routine 66 in case path 32 and or endpoint 35 can be refined or should be updated (due to, for example, improved height H_{c}, distance D_{c}, or offset angle α_{c} information due to closer resolution or additional image data 55), including as vehicle moves closer to trailer 16. Still further, the coupler 14 can be assumed to be static such that the position of vehicle 12 can be tracked by continuing to track the coupler 14 to remove the need for use of the dead reckoning device 24.

As an additional measure, while completing the automated hitching maneuver, the controller 26 can further attempt to identify the hitch ball 34 of the vehicle 12 within the image data 55. In various examples, this can be done initially or when the vehicle 12 moves to within a predetermined distance of the coupler 14. If no hitch ball 34 is detected at the desired interval, the controller 26 can cause the vehicle 12 to stop and can also present an indication 94, via the vehicle-human machine interface 40 that a hitch ball 34 should be assembled with the vehicle 12, as shown in FIG. 7. The operating routine 68 can then pause until the user confirms (e.g., by way of a touchscreen 42 input) that the hitch ball 34 has been assembled with the vehicle 12. Once the confirmation is received, the controller 26 can check again to confirm that the hitch ball 34 is present before resuming and completing the operating routine 68.

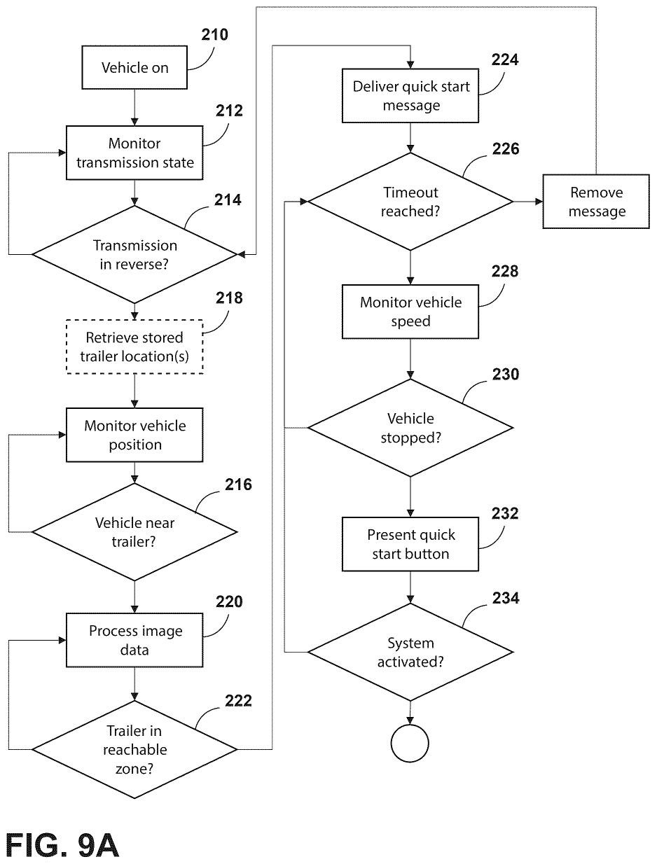

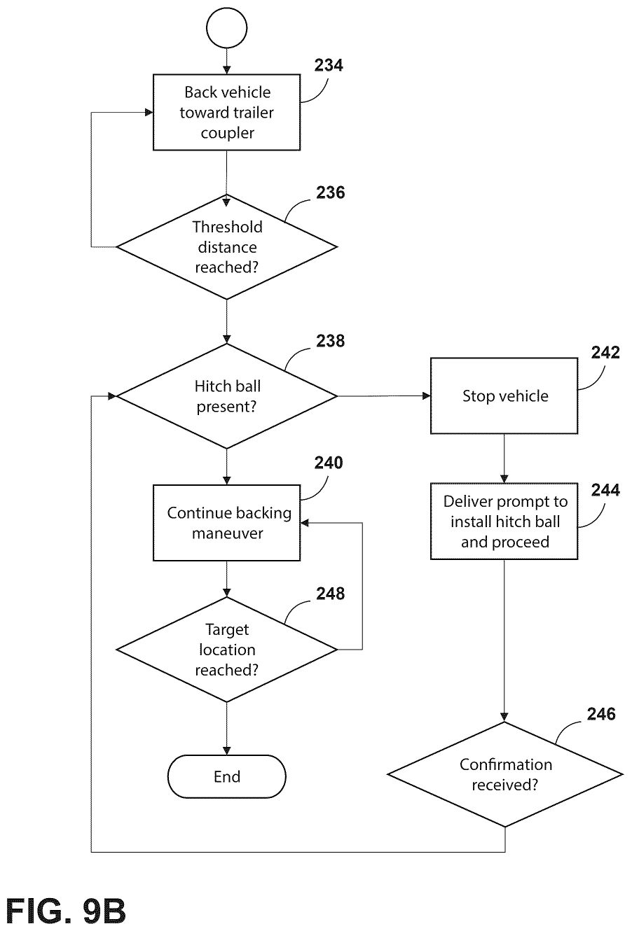

Turning now to FIGS. 9A and 9B, a flowchart showing steps in using hitch assist system 10 to align a vehicle hitch ball 34 with a coupler 14a of a subject trailer 16a is shown. In one aspects, these steps may form the basis for operation of the system 10 or otherwise carrying out an automated hitching process. In particular, the when vehicle 12 is turned on, or is running, (step 210), the system 10 monitors the state of the transmission system 92 to determine if the vehicle 10 is in reverse (step 212). If the transmission 92 is in reverse (step 214), the system 10 checks if the vehicle is proximate to any trailers 16 using either or both of the imaging system 18 or the GPS module 25 to identify any trailer 16 to the rear of the vehicle 12 or otherwise determine that a trailer 16 is within a desired distance of the vehicle 12 (step 216). As discussed above, this may be accomplished by retrieving stored trailer locations from the memory 62 (which may be stored based on previous connections or user inputs) (step 218). Controller 26 then processes the image data 55 to determine if the nearby trailer 16 is within the reachable, or target, zone 45 using one imaging system 18 and image processing routine 64 (step 220). The vehicle 12 position 28 is continuously monitored when nearby a trailer such that subsequent steps can be taken whenever the trailer 16 is brought into the target zone 45. (step 222). When such a condition is met the initial quick start message 90a is delivered to the driver, informing them that the system is ready to begin the alignment process (step 224).

The system monitors for a timeout condition (e.g., 15 to 30 seconds) to ensure the process does not take too long without progress (step 226). The vehicle speed is monitored (step 228) to determine if the vehicle is stopped such that the automated hitching process can begin, in response to the initial message 90a (step 230). If the vehicle 12 stops, the quick start button 90b is presented to the driver, allowing them to start the operation routine 68 of system 10 quickly (step 232), with the quick start message 90a being removed once the button 90b is pressed (step 234). The system then proceeds with the automated hitching routine 68, as discussed above. During the operation, the system 10 can check if the vehicle 12 has reached a threshold distance (e.g., 1 or 2 m) from the trailer 16, indicating that it is close enough to begin precise alignment (step 236), and verifies the presence of the hitch ball 34 (step 238). If the hitch ball 34 is present, the vehicle 12 is then backed toward the trailer coupler, guided by the system to ensure accurate alignment (step 240). If the hitch ball 34 is not installed, the vehicle is stopped (step 242) a prompt 98 is delivered to the driver to install the hitch ball 34 before proceeding with the final alignment (step 244). Upon confirmation that the hitch ball 34 is installed (step 246), the backing maneuver continues until the vehicle 12 reaches the endpoint of the alignment process (step 248), whereby the trailer 16 coupler 14 can be lowered for connection. The system then stops the vehicle, completing the process.

It is to be understood that variations and modifications can be made on the aforementioned structure without departing from the concepts of the present disclosure, and further it is to be understood that such concepts are intended to be covered by the following claims, unless these claims by their language expressly state otherwise.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A hitching assistance system for a vehicle, comprising:
an imager mounted with and directed away from a rear of the vehicle and outputting image data;
a transmission state indicator mounted within the vehicle;
a vehicle-human machine interface positioned within the vehicle; and
a controller:
monitoring the transmission indicator, and responsive to the transmission indicator corresponding with the vehicle being in reverse:
acquiring image data from the imager;
identifying a trailer within the image data; and
responsive to identifying the trailer within the image data, presenting, via the vehicle-human machine interface, an option for user selection for initiation of an automated hitching maneuver; and
responsive to acceptance of the option for user selection for the automated hitching maneuver, outputting a steering signal to the vehicle to cause the vehicle to steer to position the vehicle relative to the trailer such that the trailer can be coupled with the vehicle.

2. The hitching assistance system of claim 1, wherein:
the controller further, responsive to the transmission indicator corresponding with the vehicle being in reverse, determines a trailer target area to a rear of the vehicle; and
presents the option for user selection for initiation of the automated hitching maneuver, further responsive to at least a portion of the trailer being within the trailer target area.

3. The hitching assistance system of claim 2, wherein:
the controller further identifies a coupler of the trailer within the image data; and
the portion of the trailer within the trailer target area is the coupler of the trailer.

4. The hitching assistance system of claim 2, wherein the trailer target area is:
positioned within left and right lateral vehicle steering limits;
defined in a lateral direction between left and right boundaries respectively spaced inwardly of the left and right lateral vehicle steering limits by one of a system perception factor or a vehicle geometry factor; and
defined in a longitudinal direction between a minimum movement limit and a maximum perception limit.

5. The hitching assistance system of claim 1, wherein the option for user selection for initiation of the automated hitching maneuver is presented within a quick-start mode implemented by the controller responsive to identifying the trailer within the image data.

6. The hitching assistance system of claim 5, wherein the controller deactivates the quick-start mode after a predetermined interval with no acceptance of the option for user selection for initiation of the automated hitching maneuver.

7. The hitching assistance system of claim 1, wherein:
while outputting the steering signal to the vehicle to cause the vehicle to steer to position the vehicle relative to the trailer such that the trailer can be coupled with the vehicle, the controller further attempts to identify a vehicle hitch ball within the image data; and
responsive to not detecting a hitch ball when the vehicle moves to within a predetermined distance of the trailer:
causing the vehicle to stop; and
presenting, via the vehicle-human machine interface, an indication that a hitch ball should be assembled with the vehicle.

8. The hitching assistance system of claim 1, wherein the option for user selection for initiation of the automated hitching maneuver is presented as a top-level selection item on the vehicle-human machine interface.

9. The hitching assistance system of claim 8, wherein the top-level selection item on the vehicle-human machine interface is presented as an overlay on at least a portion of the image data presented on a display of the vehicle-human machine interface.

10. The hitching assistance system of claim 9, wherein the controller further presents an indication of the identified trailer as a second overlay on the portion of the image data.

11. The hitching assistance system of claim 1, further including a GPS module and memory including a stored location of a trailer, wherein:
responsive to the transmission indicator corresponding with the vehicle being in reverse, the controller can further monitor a position of the vehicle relative to the stored location of the trailer using the GPS module and presenting the option for user selection for initiation of the automated hitching maneuver in further response to the vehicle being within a predetermined positioning relative to the stored location of the trailer.

12. A hitching assistance system for a vehicle, comprising:
an imager mounted with and directed away from a rear of the vehicle and outputting image data;
a GPS module positioned within the vehicle;
a transmission state indicator mounted within the vehicle;
a vehicle-human machine interface positioned within the vehicle; and
a controller:
monitoring the transmission indicator, and responsive to the transmission indicator corresponding with the vehicle being in reverse:
using at least one of the imager or the GPS module, determining if the vehicle is within a predetermined position relative to a trailer; and
responsive to determining that the vehicle is within the predetermined position relative to the trailer, presenting, via the vehicle-human machine interface, an option for user selection for initiation of an automated hitching maneuver; and
responsive to acceptance of the option for user selection for the automated hitching maneuver, outputting a steering signal to the vehicle to cause the vehicle to steer to position the vehicle relative to the trailer such that the trailer can be coupled with the vehicle.

13. The hitching assistance system of claim 12, wherein
the imager is used to determine if the vehicle is within a predetermined position relative to a trailer;
the controller further identifies a coupler of the trailer; and
the predetermined position of the vehicle relative to the trailer corresponds with the coupler of the trailer being within a trailer target area relative to the vehicle.

14. The hitching assistance system of claim 12, further including memory storing a known location of the trailer, wherein:
the controller uses the GPS module to determine if the vehicle is within the predetermined position relative to the trailer based on location data of the vehicle relative to the known location of the trailer.

15. The hitching assistance system of claim 14, wherein the predetermined position includes a distance between the vehicle and the known location of the trailer and a heading of the vehicle.

16. The hitching assistance system of claim 12, wherein the option for user selection for initiation of the automated hitching maneuver is presented within a quick-start mode implemented by the controller responsive to identifying the trailer within the image data.

17. The hitching assistance system of claim 16, wherein the controller deactivates the quick-start mode after a predetermined interval with no acceptance of the option for user selection for initiation of the automated hitching maneuver.

18. The hitching assistance system of claim 12, wherein:
while outputting the steering signal to the vehicle to cause the vehicle to steer to position the vehicle relative to the trailer such that the trailer can be coupled with the vehicle, the controller further attempts to identify a vehicle hitch ball within the image data; and
responsive to not detecting a hitch ball when the vehicle moves to within a predetermined distance of the trailer:
causing the vehicle to stop; and
presenting, via the vehicle-human machine interface, an indication that a hitch ball should be assembled with the vehicle.

19. The hitching assistance system of claim 12, wherein the option for user selection for initiation of the automated hitching maneuver is presented as a top-level selection item on the vehicle-human machine interface an overlay on at least a portion of the image data presented on a display of the vehicle-human machine interface.

20. A vehicle, comprising:
a steering system
a transmission system;
an imager mounted with and directed away from a rear of the vehicle and outputting image data;
a GPS module;
a vehicle-human machine interface positioned within the vehicle; and
a controller:
monitoring a state of the transmission, and responsive to the state of the transmission corresponding with the vehicle being in reverse:
using at least one of the imager or the GPS module, determining if the vehicle is within a predetermined position relative to a trailer; and
responsive to determining that the vehicle is within the predetermined position relative to the trailer, presenting, via the vehicle-human machine interface, an option for user selection for initiation of an automated hitching maneuver; and
responsive to acceptance of the option for user selection for the automated hitching maneuver, outputting a steering signal to the vehicle to cause the vehicle to steer to position the vehicle relative to the trailer such that the trailer can be coupled with the vehicle.
